(19) United States
(12) Patent Application Publication
(10) Pub. No.: US 2010/0238818 A1
(43) Pub. Date: Sep. 23, 2010

(54) WIRELESS COMMUNICATION MOBILE STATION APPARATUS AND COMMUNICATION QUALITY INFORMATION GENERATING METHOD

(75) Inventors: Shinsuke Takaoka, Kanagawa (JP); Akihiko Nishio, Kanagawa (JP)

Correspondence Address: Dickinson Wright PLLC;James E. Ledbetter, Esq., International Square, 1875 Eye Street, N.W., Suite 1200, Washington, DC, 20006, US

(73) Assignee: Panasonic Corporation, Osaka (JP)

(21) Appl. No.: 12/682,201

(22) PCT Filed: Sep. 10, 2008
(86) PCT No.: PCT/JP2008/002875

§ 371 Date: Apr. 8, 2010

(30) Foreign Application Priority Data
Oct. 11, 2007 (JP) 2007-265527

(51) Int. Cl. H04L 12/26

(52) U.S. Cl. 370/252

(57) ABSTRACT

A wireless communication mobile station apparatus wherein the accuracy of measuring the communication quality can be improved. In this apparatus, a desired signal power measuring part (212) uses a reference signal received from a local-cell reference signal processing part (211) to measure the power of a desired signal addressed to the local apparatus. An interference signal power measuring part (214) uses a reference signal received from an other-cell reference signal processing part (213) to measure an other-cell interference signal power removable by retransmission. An interference power calculating part (215) then uses a reference signal received from the separating part (203), the desired signal power received from the desired signal power measuring part (212) and the removable-by-retransmission other-cell interference signal power received from the interference signal power measuring part (214) to calculate an interference power that is a sum of the removable-by-retransmission other-cell interference signal power and the noise power. A communication quality generating part (216) then uses the desired signal power (S) and the sum of the removable-by-retransmission other-cell interference signal power and the noise power to generate communication quality information of the signal addressed to the local apparatus.

### TECHNICAL FIELD

The present invention relates to a radio communication mobile station apparatus and a communication quality information generating method.

### BACKGROUND ART

In a mobile communication system such as LTE (Long Term Evolution) standardized by 3GPP, data retransmission control referred to as “HARQ” (Hybrid Automatic Repeat reQuest), which is a combination of error collection coding and automatic retransmission request, is under study. HARQ is able to improve received quality on the receiving side by combining retransmission data and data received last time with an error when receiving retransmitted data (packet). A mobile communication system using HARQ allows high throughput data transmission. As a data retransmission method using HARQ, CC (Chase Combining) that transmits the same bit sequence as in the first transmission and IR (Incremental Redundancy) that transmits a parity bit coded differently from the first transmission.

In addition, as a method of operating HARQ in a mobile communication system, there are asynchronous HARQ and synchronous HARQ. With asynchronous HARQ, the transmitting and receiving timings for a retransmission are not determined in the first transmission, and therefore it is necessary to report the transmitting and receiving timings for the retransmission to the receiving side every time a retransmission occurs, using control information. However, asynchronous HARQ can flexibly adapt to data transmission timings, transmission order and so forth for a plurality users and therefore can effectively utilize a scheduling function provided on the transmitting side. On the other hand, with synchronous HARQ, a timing to generate retransmission data is determined in the first transmission, and this information is reported as a control signal, along with a data signal, to the receiving side in the first transmission. Thus, synchronous HARQ has a characteristic allowing a decrease in the number of control information bits because it is not necessary to transmit new control information in a retransmission.

Meanwhile, as a scheduling method for providing applications such as VoIP (Voice over Internet Protocol) and streaming, Persistent Scheduling that allocates a radio resource pattern such as a frequency every certain period is under study.

Here, when synchronous HARQ is used in persistent scheduling, transmitting and receiving timings in the first transmission and retransmission are preset in each cell. Therefore, the data collision rate between cells at the same time is higher and the influence of interference from neighboring cells is greater. Therefore, as a method for reducing this interference, there is orthogonal phase control that multiplies transmission data from a radio communication base station apparatus (hereinafter referred to as “base station”) to a radio communication mobile station apparatus (hereinafter referred to as “mobile station”) between cells by orthogonal sequences differing between cells. By this means, even if a desired signal of the cell in which the mobile station is located and interference signals from other cells in which the mobile station is not located are combined with a received signal, the desired signal and interference signals are orthogonal to each other by repeating retransmissions, and therefore the mobile station can cancel interference signals from the received signal.

Moreover, retransmission control that allows a plurality of times of retransmissions to transmit data is under study (e.g., see Non-Patent Document 1). This retransmission control is performed to transmit data normally by presetting execution of a plurality of times of retransmissions and repeating the set number of times of retransmissions. By this means, the communication quality acquired by the combined gain in the retransmission can be estimated in the first transmission. Consequently, data can be more efficiently transmitted by executing transmission control adapted to the communication quality acquired by retransmissions.

As transmission control taking into account this retransmission control, there is retransmission control that improves frequency efficiency by designing retransmission control and AMC (Adaptive Modulation and channel Coding) that adaptively controls the coding rate for channel coding in a cross-layer architecture. Here, MCS (Modulation and channel Coding Scheme) is selected taking into account retransmission control allowing a plurality of times of retransmissions and the combined gain by retransmissions. In addition, as an example of transmission control, there is transmission power control that adaptively controls the transmission power of transmission data in accordance with the communication quality between transmission and reception. With transmission power control, each mobile station measures the SINR (Signal to Interference and Noise Ratio) of a reference signal and generates communication quality information from the measured SINR. Then, each mobile station reports the communication quality information to the base station. The base station controls the transmission power of retransmission data based on the communication quality information from each mobile station and retransmits the retransmission data to each mobile station.
Non-Patent Document 1: Q. Liu, S. Zhou, and G. B. Giannakis, “Cross-Layer Combining of Adaptive Modulation and Coding with Truncated ARQ over Wireless Links”, IEEE Transaction on Wireless Communications, vol. 3, No. 5, pp. 1746-1755, September 2004.

### DISCLOSURE OF INVENTION

### Problems to be Solved by the Invention

When retransmission control allowing a plurality of times of retransmissions and orthogonal phase control are combined for use, a mobile station can acquire combined gain by retransmissions control and an effect of reducing interference by orthogonal phase control. Nevertheless the mobile station measures communication quality based on the desired signal and interference signals included in a received signal. That is, despite the fact that interference signals can be canceled through a plurality of times of retransmissions, the mobile station measures communication quality, including interference signals that can be canceled by retransmissions. Therefore, although the mobile station measures communication quality taking into account the combined gain acquired by retransmissions from the first transmission, the power of interference signals canceled by retransmissions is not taken into account, and therefore the communication quality lower by this power is measured. Thus, when orthogonal sequences are applied, the interference signal power that can be canceled by retransmissions is not reflected on communication quality measurement, and therefore the accuracy of communication quality measurement deteriorates.

It is therefore an object of the present invention to provide a radio communication mobile station apparatus and a communication quality information generating method that can improve the accuracy of communication quality measurement.

### Means for Solving the Problem

The mobile station according to the present invention has a configuration including: a first measuring section that measures a power of a desired signal; a second measuring section that measures a first interference power that can be canceled by a retransmission; a calculating section that calculates a second interference power not that can be canceled by the retransmission based on a power of a received signal, the power of the desired signal and the first interference power; and a generating section that generates communication quality information using the power of the desired signal and the second interference power.

### Advantageous Effects of Invention

According to the present invention, the accuracy of communication quality measurement can be improved.

### BRIEF DESCRIPTION OF DRAWINGS

FIG. 1 is a block configuration diagram of a base station according to embodiment 1 of the present invention;

FIG. 2 is a block configuration diagram of a mobile station according to embodiment 1 of the present invention;

FIG. 3 is a drawing showing a method for generating communication quality information using the received signal power from which interference signal power from other cells that can be canceled by retransmissions is canceled according to embodiment 1 of the present invention;

FIG. 4 is a flowchart showing steps of data transmission processing according to embodiment 1 of the present invention;

FIG. 5 is a drawing showing a layout of base stations in other cells with different received signals;

FIG. 6 is a drawing showing differences in power between interference signals from other cells according to embodiment 2 of the present invention;

FIG. 7 is a drawing showing a method for allocating sequences to cells according to embodiment 2 of the present invention;

FIG. 8 is a drawing showing different channel correlations in interference from other cells according to embodiment 3 of the present invention;

FIG. 9 is a drawing showing a method for allocating sequences to cells according to embodiment 3 of the present invention.

### BEST MODE FOR CARRYING OUT THE INVENTION

Now, embodiments of the present invention will be described in detail with reference to the accompanying drawings.

### Embodiment 1

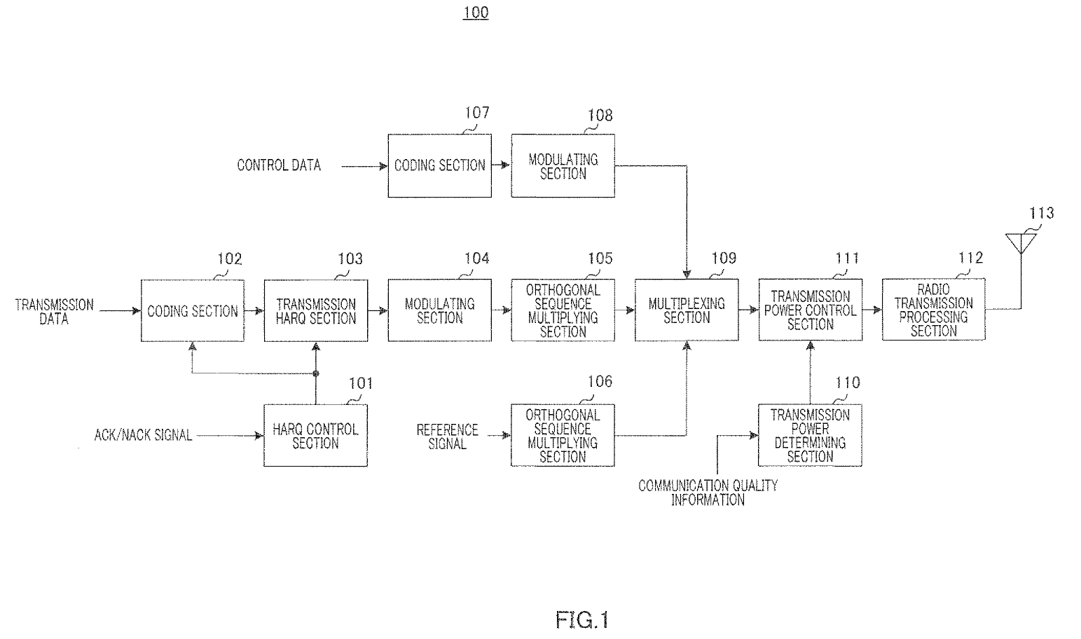

FIG. 1 is a block diagram showing a configuration of base station 100 according to the present embodiment.

HARQ control section 101 performs data retransmission control based on ACK (ACKnowledgement)/NACK (Negative ACKnowledgement) signals inputted from a receiving section (not shown). To be more specific, when an ACK signal is received from the receiving section (not shown) as input, HARQ control section 101 controls coding section 102 to encode new data and also controls transmission HARQ section 103 to transmit this new data. On the other hand, when a NACK signal is received from the receiving section (not shown) as input, HARQ control section 101 controls coding section 102 to encode retransmission data in accordance with the same coding rate as in the first transmission and also controls transmission HARQ section 103 to transmit retransmission data with the same RM (Rate Matching) parameter as in the first transmission.

Coding section 102 encodes transmission data in accordance with the coding rate inputted from HARQ control section 101 and outputs the coded data to transmission HARQ section 103.

Transmission HARQ section 103 performs rate matching of the coded data inputted from coding section 102 based on the RM parameter inputted from HARQ control section 101. Then, transmission HARQ section 103 outputs the coded data after adjusting the rate to modulating section 104. To be more specific, the processing of rate matching involves, for example, puncturing and repetition of coded data. Here, the CC method is employed as the data retransmission method in HARQ.

Modulating section 104 modulates the coded data inputted from transmission HARQ section 103 and outputs the data signal after the modulation to orthogonal sequence multiplying section 105.

Orthogonal sequence multiplying section 105 multiplies the data signal inputted from modulating section 104 by the orthogonal sequence allocated to the cell in which base station 100 is located, among a plurality of quadrature sequences differing every cell, and outputs the data signal after the orthogonal sequence multiplication to multiplexing section 109.

Orthogonal sequence multiplying section 106 multiplies a reference signal used for channel estimation, measurement of desired signal power or measurement of interference signal power by the orthogonal sequence allocated to the subject cell, among a plurality of orthogonal sequences differing every cell and outputs the reference signal after the orthogonal sequence multiplication to multiplexing section 109.

Coding section 107 encodes the inputted control data (e.g., information of the orthogonal sequence allocated to each cell, information of the coding rate for channel coding, information of the modulation method and so forth) and generates coded data. Modulating section 108 performs modulation processing of the coded data inputted from coding section 107 and outputs a control signal after the modulation to multiplexing section 109.

Multiplexing section 109 multiplexes the data signal after orthogonal sequence multiplication inputted from orthogonal sequence multiplying section 105, the reference signal after orthogonal sequence multiplication inputted from orthogonal sequence multiplying section 106 and the control signal inputted from modulating section 108, and outputs a multiplexed signal to transmission power control section 111.

Transmission power determining section 110 determines transmission power for a signal directed to each mobile station based on the communication quality such as SINR reported from each mobile station. Then, transmission power determining section 110 outputs the determined transmission power information to transmission power control section 111.

Transmission power control section 111 controls the transmission power for the multiplexed signal outputted from multiplexing section 109 in accordance with the transmission power information inputted from transmission power determining section 110 and outputs the signal after the transmission power control to radio transmission processing section 112.

Radio transmission processing section 112 performs radio transmission processing, including up-conversion and so forth, of the signal inputted from transmission power control section 111 and transmits the processed signal via antenna 113.

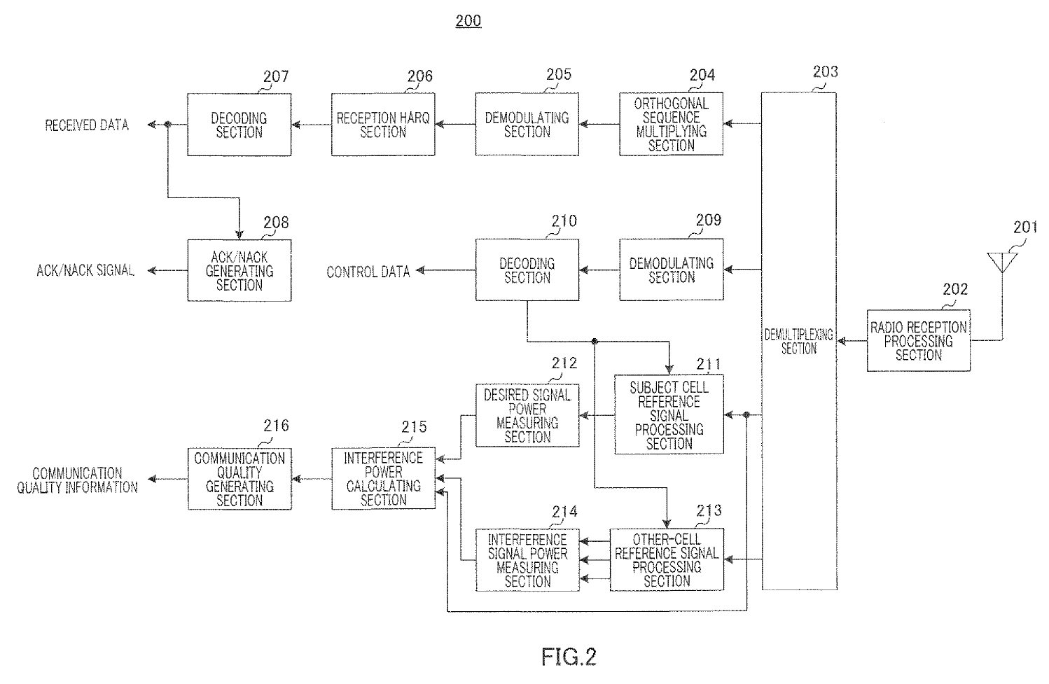

FIG. 2 is a block diagram showing a configuration of mobile station 200 according to the present embodiment.

Radio reception processing section 202 performs radio reception processing, including down-conversion and so forth, of the signal received via antenna 201 and outputs the acquired received signal to demultiplexing section 203.

Demultiplexing section 203 demultiplexes the received signal inputted from radio reception processing section 202 into the data signal (information data), the control signal (control data) and the reference signal. Then, Demultiplexing section 203 outputs the data signal to orthogonal sequence multiplying section 204, outputs the control signal to demodulating section 209 and outputs the reference signal to subject cell reference signal processing section 211, other-cell reference signal processing section 213 and interference power calculating section 215.

Orthogonal sequence multiplying section 204 multiplies the data signal inputted from demultiplexing section 203 by the complex conjugate of the orthogonal sequence allocated to the subject cell is located, and outputs the multiplication result to demodulating section 205.

Demodulating section 205 performs demodulation processing of the data signal inputted from orthogonal sequence multiplying section 204 and outputs the data signal after the demodulation to reception HARQ section 206.

In the first transmission, reception HARQ section 206 outputs the data signal inputted from demodulating section 205 to decoding section 207 and stores the soft decision value of the data signal. Meanwhile, when data is retransmitted, reception HARQ section 206 combines the stored soft decision value in the first transmission with the soft decision value in the retransmission and generates a combined signal. Then, reception HARQ 206 outputs the combined data signal to decoding section 207.

Decoding section 207 performs decoding processing of the data signal inputted from reception HARQ section 206 to acquire received data. In addition, decoding section 207 outputs the received data to ACK/NACK generating section 208.

ACK/NACK generating section 208 detects whether or not an error is included in the received data based on a result of CRC (Cyclic Redundancy Check) of the received data and so forth and generates an ACK/NACK signal (ACK signal or NACK signal). Here, the ACK/NACK signal is transmitted to base station 100 via a transmitting section (not shown).

Meanwhile, demodulating section 209 performs demodulation processing of the control signal inputted from demultiplexing section 203 and the demodulated control signal to decoding section 210. In addition, decoding section 210 performs decoding processing of the control signal inputted from demodulating section 209 to acquire control data. Moreover, decoding section 210 outputs orthogonal sequence information indicated in the control data to subject cell reference signal processing section 211 and other-cell reference signal processing section 213.

Subject cell reference signal processing section 211 multiplies the reference signal inputted from demultiplexing section 203 by the orthogonal sequence allocated to the subject cell, among a plurality of orthogonal sequences differing every cell, using the orthogonal sequence information inputted from decoding section 210. Then, subject cell reference signal processing section 211 outputs the reference signal after the orthogonal sequence multiplication to desired signal power measuring section 212.

Desired signal power measuring section 212 measures the power of the desired signal directed to the mobile station 200 using the reference signal inputted from subject cell reference signal processing section 211. Then, desired signal power measuring section 212 stores the measured desired signal power (S) and outputs the measured desired signal power (S) to interference power calculating section 215. In addition, when data is retransmitted, desired signal power measuring section 212 adds the stored desired signal power of the data having been transmitted and the desired signal power of the retransmission data and outputs the desired signal power after the addition to interference signal power calculating section 215.

Other-cell reference signal processing section 213 multiplies the reference signal inputted from demultiplexing section 203 by the orthogonal sequence allocated to another cell, among a plurality of orthogonal sequences differing every cell, using the orthogonal sequence information inputted from decoding section 210. Then, other-cell reference signal processing section 213 outputs the reference signal after the orthogonal sequence multiplication to interference signal power measuring section 214.

Interference signal power measuring section 214 measures the interference signal power from other cells to which any one of orthogonal sequences is allocated, that is, measures the interference signal power from other cells that can be canceled by retransmissions, using the reference signal inputted from other-cell reference signal processing section 213. Then, interference signal power measuring section 214 stores interference signal power from other cells that can be canceled by retransmissions (I₁) and outputs it to interference power calculating section 215. In addition, when data is retransmitted, interference signal power measuring section 214 adds the stored interference signal power from other cells, which is measured from the first transmission to the last transmission, and the interference signal power from other cells, which is measured in the retransmission and outputs the interference signal power from other cells after the addition to interference power calculating section 215. Here, for example, other-cell reference signal processing section 213 calculates the sum of the power of interference signals from other cells to which orthogonal sequences are allocated, by calculating the square-sum of the reference signals resulting from multiplying the complex conjugates of different orthogonal sequences allocated to other cells, respectively.

Interference power calculating section 215 calculates the interference power other than interference signal power from other cells that can be canceled by retransmissions (I₁), using the reference signal inputted from demultiplexing section 203, desired signal power (S) inputted from desired signal power measuring section 212 and interference signal power from other cells that can be canceled by retransmissions (I₁) inputted from interference signal power measuring section 214. To be more specific, interference power calculating section 215 calculates the sum of interference power other than interference signal power from other cells that can be canceled by retransmissions (I₁), that is, interference signal power from other cells that cannot be canceled using orthogonal sequences (I₂), and noise power (N), using the reference signal, desired signal power (S) and interference signal power from other cells that can be canceled by retransmissions (I₁). For example, interference power calculating section 215 subtracts desired signal power (S) and interference signal power from other cells that can be canceled by retransmissions (I₁), from the received signal power of the reference signal after packet combining, which is outputted from demultiplexing section 203 (the sum of desired signal (S), interference signal power from other cells that can be canceled by retransmissions (I₁), interference signal power from other cells that cannot be canceled by retransmissions (I₂) and noise power (N)). The power acquired by this is interference signal power (I₂+N) consisting of the sum of interference signal power from other cells that cannot be canceled by retransmissions (I₂) and noise power (N). Then, interference power calculating section 215 outputs the calculated desired signal power (S) and interference power (I₂+N) to communication quality generating section 216.

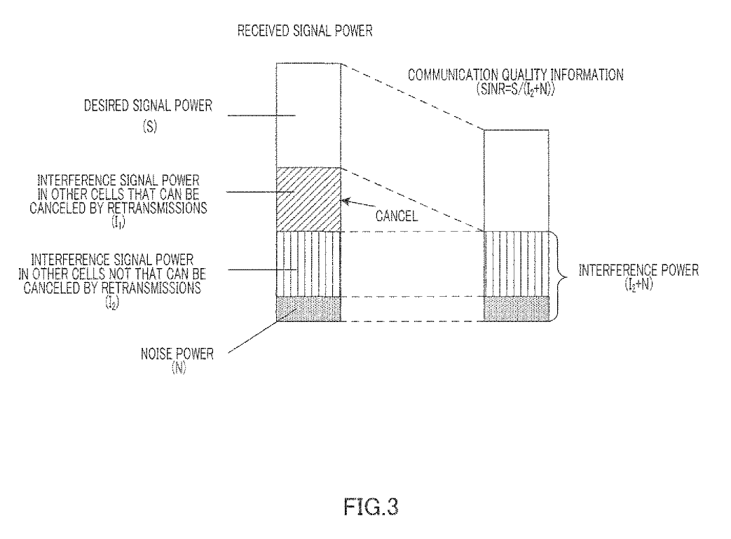

Communication quality generating section 216 generates communication quality information of the signal directed to the mobile station 200 using desired signal power (S) and the sum (I₂+N) of interference signal power from other cells that cannot be canceled by retransmissions (I₂) and noise power (N). This communication quality information is used for determining the transmission power for transmission data in the base station. To be more specific, communication quality generating section 216 generates communication quality information based on the received signal power from which interference signal power from other cells that can be canceled by retransmissions (I₁) is canceled, as shown in FIG. 3. That is, when SINR is used as communication quality information, communication quality generating section 216 generates communication quality information by calculating the ratio between desired signal power (S) and the sum (I₂+N) of interference signal power from other cells that cannot be canceled by retransmissions (I₂) and noise power (N), that is, S/(I₂+N), as shown in FIG. 3. Then, when there is no error in the desired signal (when ACK/NACK generating section 208 generates an ACK signal), communication quality generating section 216 reports the communication quality information to base station 100 via the transmitting section (not shown).

As described above, mobile station 200 reports the communication quality at the time of successful packet transmission reflecting the effect of reducing interference from other cells by using orthogonal sequences and the combined gain of the desired signal by retransmissions, to base station 100. By this means, base station 100 can reduce the transmission power required to satisfy the required quality and can prevent interference to other mobile stations. In addition, mobile station 200 reports communication quality information to base station 100 only at the time the packet transmission is successful, and therefore the amount of control information can be minimized.

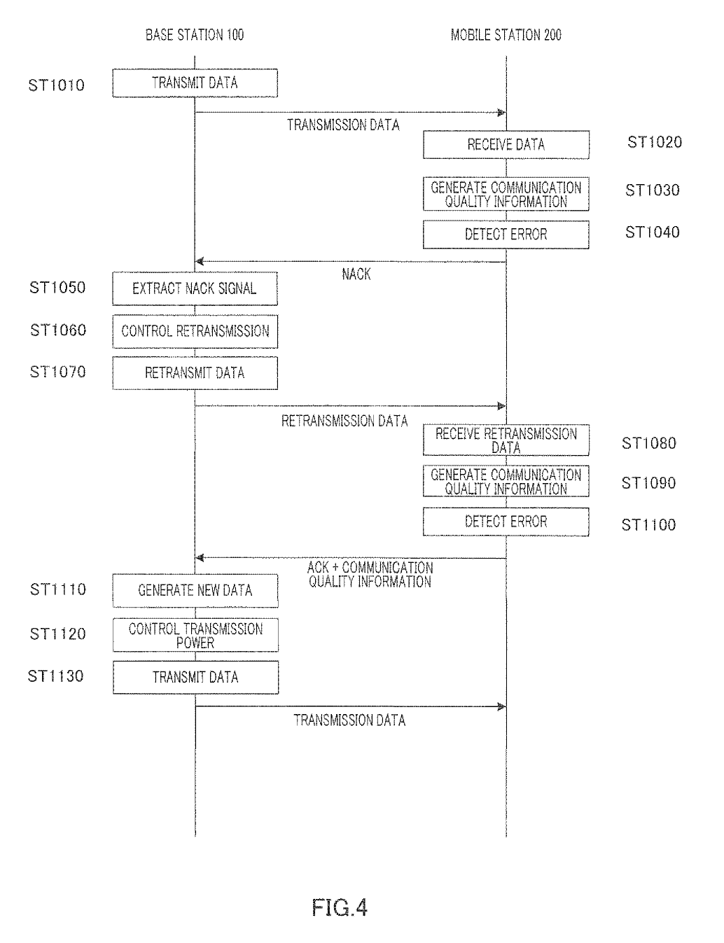

Next, the steps of data transmission processing in base station 100 and mobile station 200 having the above-described configuration will be explained with reference to the flowchart shown in FIG. 4.

Base station 100 transmits data to mobile station 200 (ST (step) 1010). Mobile station 200 receives this data via reception antenna 201 (ST 1020) and acquires data after decoding and communication quality information (ST 1030).

Next, ACK/NACK generating section 208 performs error detection on the received signal by CRC check of the decoded data (ST 1040). Then, when a reception error is detected, ACK/NACK generating section 208 generates a NACK signal to request a data retransmission to base station 100. The NACK signal is transmitted to base station 100 through the transmitting section (not shown). Here, when a reception error is detected, the generated communication quality information is not transmitted to base station 100.

Next, in base station 100, the receiving section (not shown) extracts the NACK signal (ST 1050). When the NACK signal is received as input, HARQ control section 101 outputs a command to generate transmission data for retransmission to transmission HARQ section 103 to perform retransmission control (ST 1060). Then, modulation, multiplexing, transmission power and radio transmission processing, which are the same processing as those in the first transmission, are applied to the retransmission data, and the processed retransmission data is retransmitted via transmission antenna 113 (ST 1070). Here, although orthogonal sequence multiplying section 105 uses the first element of orthogonal sequence in the first transmission, the second element of orthogonal sequence is used in the second transmission (the first retransmission). Hereinafter, orthogonal sequence multiplying section 105 uses the n-th element of the orthogonal sequence will be used in the n-th transmission ((n−1)-th retransmission).

Mobile station 200 receives retransmission data (ST 1080) and acquires data and communication quality information after decoding (ST 1090). Here, the communication quality information in data retransmission is calculated as follows. Here, the n-th data transmission ((n−1)-th retransmission) will be described.

First, in the same manner as in the first transmission, desired signal power measuring section 212 measures desired signal power (S) in the n-th data transmission ((n−1)-th retransmission) and interference signal power measuring section 214 measures interference signal power from other cells that can be canceled by retransmissions (I₁). Then, desired signal power measurement section 212 adds desired signal power (S) measured in the n-th transmission to the stored desired signal combined power (S(n−1)) from the first transmission to the (n−1)-th transmission (S(n)=S(n−1)+S). In the same way, interference signal power measuring section 214 adds interference signal power from other cells that can be canceled by retransmissions (I₁), which is measured in the n-th transmission, to the stored combined power of interference signals from other cells that can be canceled by retransmissions from the first transmission to the (n−1)-th transmission (I₁(n−1) i.e., (I₁(n)=I₁(n−1)+I₁).

Next, interference power calculating section 215 adds the received signal power value of the reference signal measured in the n-th transmission to the stored received signal combined power of reference signals from the first transmission to the (n−1)-th transmission (the sum of the desired signal power received from the first transmission to the (n−1)-th transmission, the interference signal power from other cells that can be canceled by retransmissions, the interference signal power from other cells that cannot be canceled by retransmissions and the noise power). Then, interference power calculating section 215 calculates the interference power, which is the sum of the combined power value of interference signals from other cells that cannot be canceled by retransmissions and the combined power value of noise, by subtracting desired signal combined power S(n) and combined power of interference signals from other cells that can be canceled by retransmissions I₁(n) from the received signal combined power of the reference signal measured from the first transmission to the n-th transmission. Then, communication quality generating section 216 calculates SINR, which is the ratio between the combined power value of the desired signal and the sum of the combined power value of interference signals from other cells that cannot be canceled by retransmissions and the combined power value of noise. By this means, communication quality generating section 216 can generate communication quality information indicated by SINR excluding the influence of interference that can be reduced by retransmissions in the n-th transmission ((n−1)-th retransmission).

Next, ACK/NACK generating section 208 in mobile station 200 performs error detection on the received signal by CRC check of the decoded data. When a reception error is not detected, ACK/NACK generating section 208 generates an ACK signal to require transmission of new data to base station 100. The ACK signal and communication quality information are transmitted to base station 100 via the transmitting section (not shown). Here, when a reception error is detected, the transmission and reception processing from ST 1040 to ST 1090 described above is repeated until errors are no longer detected.

When an ACK signal is received, the receiving section (not shown) extracts the ACK signal in base station 100. When the ACK signal is received as input, HARQ control section 101 outputs a command to transmit new data (ST 1110) to coding section 102 and transmission HARQ section 103. When the command to transmit new data is received as input, coding section 102 encodes the new data and outputs coded data to transmission HARQ section 103.

Transmission power control section 111 performs minimum necessary transmission power control of the new data, which is necessary to satisfy the transmission quality such as the required PER (Packet Error Rate), BER (Bit Error Rate) and so forth based on the communication quality information reported from mobile station 200 at the time the ACK signal is received (ST 1120).

Then, radio transmission processing section 112 transmits the new data with controlled transmission power via antenna 113 (ST 1130).

As described above, according to the present embodiment, since the power of interference signals by which the orthogonal sequence is multiplied, is estimated in advance, the mobile station can measure communication quality by cancelling the interference signal power that can be canceled by retransmissions from the received power of the received signal. That is, communication quality reflecting an effect of reducing interference from other cells by retransmissions and the improvement of combined gain by retransmissions, using orthogonal sequences. Therefore, according to the present embodiment, the accuracy of communication quality measurement can be improved. In addition, according to the present embodiment, transmission power control is allowed based on the communication quality measured by the previous transmission. Therefore, it is possible to set the necessary minimum transmission power at the time each data is transmitted and it is possible to suppress the influence of interference exerted on other radio communication apparatuses using the same radio resources.

Here, with the present embodiment, although a case has been described where transmission power control is performed based on communication quality, AMC control, which adaptively changes the modulation method and the coding rate based on the above-described communication quality information, may be further performed. By this means, radio channel communication quality taking into account the effect of reducing interference from other cells by retransmissions and the combined gain of the desired signal by retransmissions, can be used for MCS selection. By this means, it is possible to select an MCS set having a higher performance modulation method (e.g., 16 QAM and 64 QAM) and a higher coding rate than before, and therefore the throughput of the system can be improved.

Moreover, with the present embodiment, although a case has been described where a different orthogonal code is allocated to each cell, a different orthogonal code may be allocated to each sector in the base station. By this means, each sector can reduce interference from other sectors (particularly, neighboring sectors) by retransmissions. Therefore, it is possible to suppress the influence of interference exerted on other radio communication apparatuses using the same radio resources, by performing transmission power control based on the communication quality of the radio channel taking into account the effect of reducing interference from other sectors. In particular, transmission power control is performed in a mobile station located in the boundary between sectors, which is easily affected by interference from other sectors, so that the effect of reducing interference can be further improved.

### Embodiment 2

In the present embodiment, sequences that are orthogonal to each other over a length shorter than their sequence length will be allocated preferentially to cells with greater interference power.

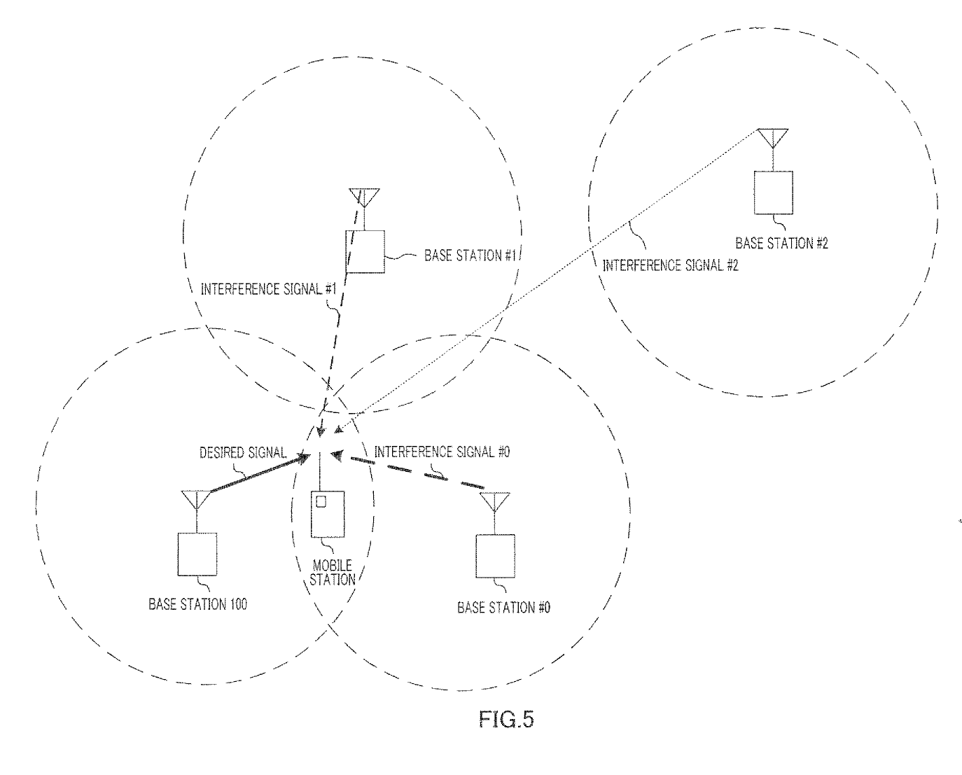

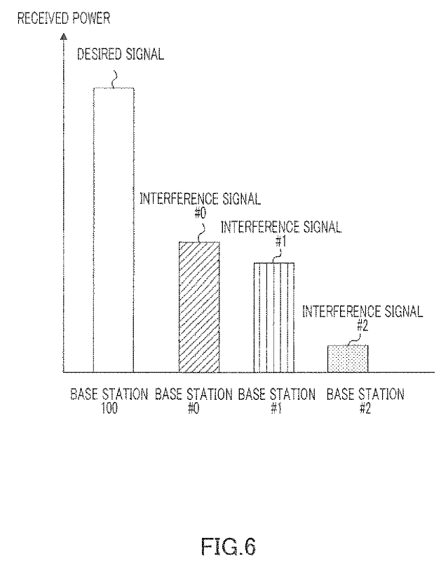

In a multicell environment as shown in FIG. 5, interference signals #0 to 2 having different received power from other cells as shown in FIG. 6 are received in the mobile station, other than the desired signal from base station 100 in communication with the mobile station. Therefore, in the present embodiment, sequences that are orthogonal to each other over a length shorter than the sequence length of each orthogonal sequence, are allocated preferentially to cells with greater interference power.

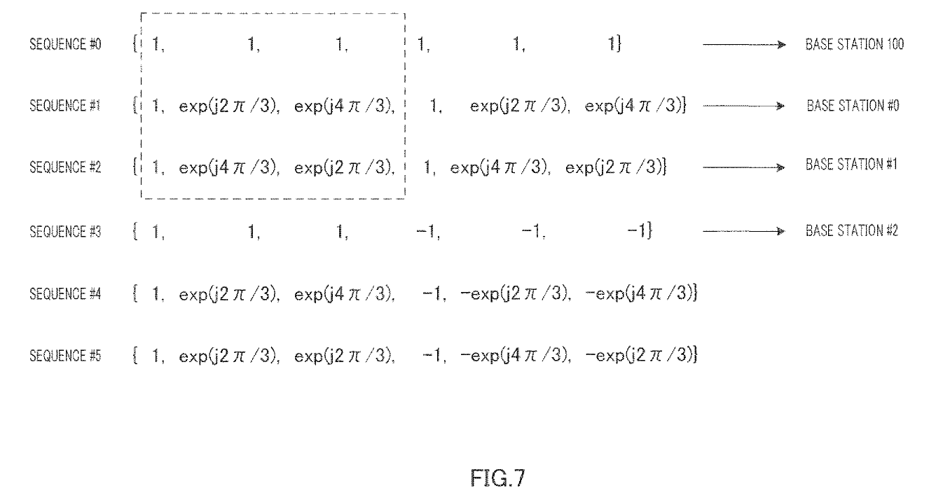

To be more specific, as shown in FIG.7, sequences #0 to #2 among sequences #0 to #5 of a sequence length of 6 are orthogonal to each other over a sequence length of 3 (within the dotted line shown in FIG. 7) in the sequence length of 6. Therefore, when base station 100 in communication with the mobile station allocates sequence #0 to the subject cell, sequence #1 and sequence #2 are allocated to base station #0 and base station #1 having greater interference power shown in FIG. 6, respectively. By employing this allocation method, although interference signals having lower power from base station #2 are cancelled by six times of retransmissions, the mobile station shown in FIG. 5 is able to cancel preferentially interference signals having greater power from base station #0 and base station #1 by three times of retransmissions, that is, by a smaller number of retransmissions.

As described above, according to the present embodiment, the influence of interference signals from other cells having greater interference power can be reduced preferentially by a smaller number of retransmissions than the orthogonal sequence length. By this means, by performing transmission power control based on communication quality reflecting this effect of reducing interference, the transmission power required to satisfy the desired quality upon each data transmission (the first transmission or retransmission) can be reduced and also the influence of interference exerted on other radio communication apparatuses using the same radio resources, can he further reduced.

### Embodiment 3

The present embodiment differs from embodiment 2 in that sequences that are orthogonal to each other over a length shorter than their sequence length among a plurality of orthogonal sequences are allocated preferentially to interfering cells and having higher channel correlation with the desired signal.

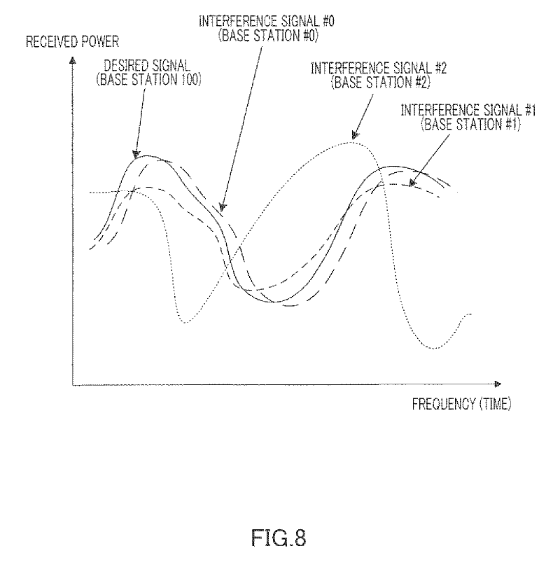

As shown in FIG. 8, the desired signal from base station 100 in communication with the mobile station and interference signals #0 to 2 from different cells are received in the mobile station with different channel correlations. Particularly, when base stations are provided adjacent each other, the radio channel correlation between the desired signal and interference signals transmitted from neighboring cells become higher. Therefore, in the present embodiment, sequences that are orthogonal to each other over a length shorter than the sequence length of each orthogonal sequence are allocated preferentially to cells generating interference signals, which have higher channel correlation with the desired signal.

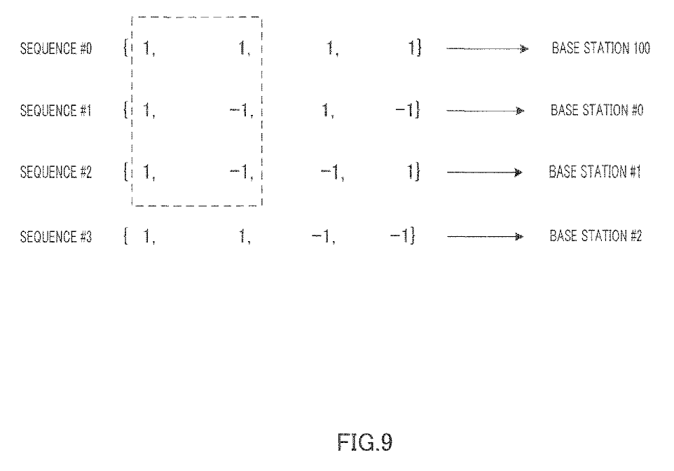

To be more specific, as shown in FIG. 9, sequences #0 to #2 among sequence #0 to #3 having a sequence length of 4 are orthogonal to each other over a sequence length of 2 (within the dotted line shown in FIG. 9) in the sequence length of 4. Accordingly, when base station 100 in communication with the mobile station allocates sequence #0 to the subject cell, sequence #1 and sequence #2 are allocated to base station #0 and base station #1 having higher channel correlation shown in FIG. 8, respectively. By employing this allocation method, although interference signals having lower channel correlation from base station #3 are cancelled by four times of retransmissions, the mobile station in communication with the base station 100 is able to cancel preferentially interference signals having greater channel correlation from base station #0 and base station #1 by two times of retransmissions, that is, by a smaller number of retransmissions.

As described above, according to the present embodiment, the influence of interference signals from other cells having greater channel correlation can be reduced preferentially through less times of retransmissions than the orthogonal sequence length. By this means, by performing transmission power control based on communication quality reflecting this effect of reducing interference, the transmission power required to satisfy the desired quality upon each data transmission (the first transmission or retransmission) can be reduced and also the influence of interference exerted on other radio communication apparatuses using the same radio resources, can be further reduced.

Here, with the present embodiment, although a case has been described where sequences that are orthogonal to each other over a length shorter than the sequence length of each orthogonal sequence are allocated preferentially to interfering cells and having higher channel correlation with the desired signal, a plurality of orthogonal sequences may be allocated to each sector in the base station according to this orthogonal code allocation. By this means, in each sector, interference from other sectors (neighboring sectors in particular) having higher correlation of the radio channel can be reduced preferentially by a smaller number of retransmissions. Therefore, an effect that it is possible to perform transmission power control based on radio channel communication quality taking into account the effect of reducing interference from other sectors, and it is possible to reduce the influence of interference exerted on the radio communication apparatuses in other sectors using the same radio resources, can be provided. In particular, by performing this transmission power control in mobile stations located in the boundary between sectors, which is easily affected by interference from other sectors, the effect of reducing interference can be further improved.

Embodiments of the present invention have been described so far.

Here, although SINR is employed as communication quality information in the above-described embodiments, SNR, SIR, CINR, MCS, CQI (Channel Quality indicator), CSI (Channel State Information) and so forth may be employed as communication quality information.

In addition, the orthogonal sequence allocation method in embodiment 2 and the orthogonal sequence allocation method in embodiment 3 may be combined. For example, as the reference for allocating orthogonal sequences to each base station, the priority based on the magnitude of interference power may be higher than the priority based on channel correlation. By this means, first, interference power from the base station having greater interference power can be reduced preferentially based on the magnitude of interference power. Then, when there are a plurality of base station having the same level of interference power, interference power from the base station having higher channel correlation can be reduced preferentially based on the degree of channel correlation.

Also, although cases have been described with the above embodiment as examples where the present invention is configured by hardware, the present invention can also be realized by software.

Each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2007-265527, filed on Oct. 11, 2007, including the specification, drawings and abstract, is incorporated herein by reference in its entirety.

### INDUSTRIAL APPLICABILITY

The present invention is applicable to mobile communication system and so forth.

1. A radio communication mobile station apparatus, comprising:
a first measuring section that measures a power of a desired signal;
a second measuring section that measures a first interference power that can be canceled by a retransmission;
a calculating section that calculates a second interference power not that can be canceled by the retransmission based on a power of a received signal, the power of the desired signal and the first interference power; and
a generating section that generates communication quality information using the power of the desired signal and the second interference power.

2. The radio communication mobile station apparatus according to claim 1, further comprising a reporting section that reports the communication quality information to radio communication base station apparatus when there is no error with the desired signal.

3. The radio communication mobile station apparatus according to claim 1, wherein:
the first measuring section measures the power of the desired signal using a signal by which an orthogonal sequence allocated to a subject cell is multiplied, among a plurality of orthogonal sequences differing every cell; and
the second measuring section measures the first interference power using a signal by which an orthogonal sequence allocated to another cell is multiplied, among the plurality of orthogonal sequences.

4. The radio communication mobile station apparatus according to claim 3, wherein the signal used to measure the power of the desired signal in the first measuring section and the signal used to measure the first interference power in the second measuring section are reference signals.

5. A method of generating communication quality information, comprising:
measuring a power of a desired signal;
measuring a first interference power that can be canceled by a retransmission;
calculating a second interference power that cannot be canceled by the retransmission based on a power of a received signal, the power of the desired signal and the first interference power; and
generating communication quality information using the power of the desired signal and the second interference power.
